(19) United States
(12) Patent Application Publication
(10) Pub. No.: US 2024/0343643 A1
(43) Pub. Date: Oct. 17, 2024

(54) SYNTHETIC GYPSUM AND GYPSUM BOARDS PRODUCED THEREFROM

(71) Applicant: UNIVERSAL CEMENT CORPORATION, Taipei (TW)

(72) Inventors: Feng-Shuo HSU, Taipei (TW); Chih-Yuan HOU, Taipei (TW)

(21) Appl. No.: 18/301,259

(22) Filed: Apr. 17, 2023

(51) Int. Cl. C04B 11/00; C04B 11/024; C04B 28/14

(52) U.S. Cl. CPC C04B 11/005; C04B 11/024; C04B 28/146; C04B 2111/00137; C04B 2111/0062

(57) ABSTRACT

This invention discloses a synthetic gypsum and gypsum boards produced therefrom. Limestone (Calcium Carbonate), slaked lime (calcium hydroxide), water, and sulfuric acid are mixed, and alpha hemihydrate gypsum is optionally added as crystal seed to produce synthetic gypsum. The synthetic gypsum is then used to make gypsum boards. The gypsum board produced according to this invention contains at least 10% alpha hemihydrate gypsum.

### BACKGROUND

### Technical Field

The present invention relates to a synthetic gypsum and a gypsum board made from the synthetic gypsum, particularly a gypsum board containing alpha-hemihydrate gypsum.

### Description of Related Art

Traditional gypsum boards do not contain alpha-hemihydrate gypsum, and their strength is relatively low. To meet the requirements of modern construction, the development of a new generation of high-strength gypsum boards has always been the focus of efforts by gypsum board manufacturers.

### DETAILED DESCRIPTION OF THE INVENTION

If gypsum (CaSO₄·2H₂O) is simply produced by reacting limestone (CaCO₃) with sulfuric acid (H₂SO₄), the resulting gypsum tends to recrystallize on the surface of the original limestone to form a layer of gypsum with low solubility. When the gypsum completely covers the original limestone core, the reaction will gradually stop at a temperature of about 45 degrees Celsius. To continue the reaction between the core limestone and sulfuric acid, an external heat source must be used so that the mixture can be stirred at higher temperatures to break the encapsulating gypsum layer in order to continue the reaction until completion.

Taking room temperature at 25 degrees Celsius as an example: as the ratio of slaked lime increases, the process temperature also increases. For example, when limestone and slaked lime are mixed in a ratio of 2:1, the process temperature can be raised to above 45 degrees Celsius; when limestone and slaked lime are mixed in a ratio of 2:8, the process temperature can reach near 80 degrees Celsius. Therefore, the present invention uses a mixture of slaked lime and limestone as raw materials to produce synthetic gypsum under normal pressure and chemical internal heat, neither external pressure nor external heat source is needed, which can achieve energy-saving and carbon reduction.

The present invention further discloses manufacture of high-strength gypsum boards containing alpha-hemihydrate gypsum from the disclosed synthetic gypsum. The gypsum boards manufactured by the present invention contain more than 10% alpha-hemihydrate calcium sulfate.

The chemical reactions related to the present invention are described as follows:

Calcium Sulfate Dihydrate (CaSO₄·2H₂O), commonly known as gypsum or dihydrate gypsum, which loses 1.5 crystalline water molecules and forms hemihydrate gypsum (CaSO₄·1/2 H₂O) upon heating:

CaSO₄·2H₂O→CaSO₄·1/2H₂O+3/2H₂O

Hemihydrate gypsum can be further divided into alpha-hemihydrate and beta-hemihydrate:

Heating dihydrate gypsum to around 97° C. leads to the formation of alpha-hemihydrate gypsum, which has a regular rhombic crystal shape. Heating dihydrate gypsum to around 45° C. leads to the formation of beta-hemihydrate gypsum, which has a loose and porous solid structure.

Calcium Carbonate (CaCO₃) reacts with Sulfuric acid and water to produce dihydrate gypsum and carbon dioxide:

$$\\ {CaCO}_{3} ( aq ) + {H}_{2} {SO}_{4} ( aq ) + {H}_{2} O ( l ) \to {CaSO}_{4} \cdot 2 {H}_{2} O ↓ + {CO}_{2} ( g ) ↑ Δ H = - 306.98 kJ / mol$$

Calcium hydroxide (Ca(OH) 2) reacts with sulfuric acid to produce dihydrate gypsum:

$$\\ {Ca ( OH )}_{2} ( aq ) + {H}_{2} {SO}_{4} ( aq ) \to {CaSO}_{4} \cdot 2 {H}_{2} O ↓ Δ H = - 428.59 kJ / mol$$

The present invention has found that gypsum boards containing alpha-hemihydrate gypsum have significantly increased physical strength compared to traditional gypsum boards that do not contain alpha-hemihydrate gypsum. Please refer to Table 1: Comparison of Physical Properties.

TABLE 1
Comparison of Physical Properties.

| | Tested Items | |
|---|---|---|
| | The present disclosed | Traditional Gypsum |
| | Gypsum Board (containing | Boards (without |
| | alpha-hemihydrate | containing alpha- |
| | gypsum over 10%) | hemihydrate gypsum) |
| Thickness | 15 mm | 15 mm |
| Longitudinal bending | 970N | 910N |
| breaking load | | |
| Transverse bending | 580N | 310N |
| breaking load | | |
| Impact resistance | hammer height 800 mm, | hammer height 800 mm, |
| | diameter of the depression | diameter of the depression |
| | less than 20 mm, and no | less than 25 mm, and no |
| | crack through the back. | crack through the back. |
| Nailed side surface load | 825N | 750N |

Table 1 shows a comparison of the physical properties between the gypsum board of the present invention and conventional gypsum board, which includes at least the following advantages:

(1) The longitudinal bending breaking load of the present invention gypsum board is 970 N, which is better than the conventional gypsum board at 910 N.

(2) The transverse bending breaking load of the present invention gypsum board is 580 N, which is better than the conventional gypsum board at 310 N.

(3) The present invention gypsum board has better impact resistance, with a dent diameter below 20 mm, compared to the conventional gypsum board with a dent diameter below 25 mm.

(4) The Nailed side surface load of the present invention gypsum board is 825 N, which is better than the conventional gypsum board at 750 N.

The present invention mixes limestone (Calcium Carbonate) and slaked lime (calcium hydroxide) in a specific ratio, and adds a predetermined amount of alpha-hemihydrate gypsum as a crystal seed for dihydrate calcium sulfate in the suspension. Under normal pressure and self-exothermic heat conditions, the mixture is reacted with sulfuric acid to synthesize dihydrate gypsum. The entire process is carried out under normal pressure and self-exothermic heat, without external heating, while controlling the concentration of reactants, pH value, drying and reaction time, to produce synthetic gypsum.

The composition analysis of the dihydrate gypsum produced by the present invention is as follows:

Synthetic gypsum analysis 1, free water analysis:
Weigh about 50 g of gypsum sample on a weighing dish and dry it at 45° C. until the weight is constant. Calculate the free water %.

Synthetic gypsum analysis 2, crystalline water % and conversion purity:
Continuing from analysis 1, weigh 1 g of gypsum and dry it at 220° C. until the weight is constant. Calculate the crystalline water % and conversion purity.

Synthetic gypsum analysis 3: Calculation of alpha-hemihydrate content %, beta-hemihydrate content %, dihydrate content %, and impurity content %:
Continuing from Synthetic gypsum analysis 1.5 g of gypsum sample is weighed and hydrated with water until the sample is completely immersed in water. The sample is then left to stand at room temperature for about 48 hours, and then dried in an oven at 45° C. until a constant weight is reached to calculate the beta-hemihydrate content %. The sample is then dried in an oven at 97° C. until a constant weight is reached to calculate the alpha-hemihydrate content %. The dihydrate content % and impurity content % are then calculated separately using a gypsum composition analyzer.
   Wherein, synthetic gypsum analysis 1 and synthetic gypsum analysis 2 are carried out according to ASTM C471M analysis method. The third analysis of synthetic gypsum uses a gypsum phase composition analyzer.

ASTM-C471M standard refers to:
ASTM-C471M Standard Test Methods for Chemical Analysis of Gypsum and Gypsum Products (Metric).

A gypsum board is also disclosed according to the present invention. The method of producing the gypsum board includes:

Step 1: Mixing limestone (Calcium Carbonate) and slaked lime (calcium hydroxide) in a ratio of 2:1˜8, adding water to make a suspension with a solid concentration of 20%˜40%, and add 0.3%˜5% alpha-hemihydrate as a crystal seed of dihydrate gypsum.

Step 2: Slowly adding 20%˜60% sulfuric acid solution in a volume equal to about 1˜1.5 times the molar amount of Calcium under normal pressure, and stirring at 150˜500 rpm. The water temperature will continue to rise to 25˜50 degrees Celsius and gas will be produced until gas production stops.

Step 3: Centrifuging dehydrating, mixing with 1˜3 times the amount of water, add 20%˜35% dilute sulfuric acid solution, stirring at 150˜500 rpm until the pH is 3˜5, let it settle and precipitate, then centrifuging and dehydrating, and washing with water three times. Drying at 105 degrees Celsius for about 2˜3 hours to produce synthetic gypsum.

The composition analysis of the synthetic gypsum produced by this invention is as follows: Free water below 10%; CaSO₄·2H₂O above 95%; particle size above 150 μm; pH value 5˜8. The alpha-hemihydrate content is about 20%˜80%, and the rest is beta-hemihydrate and impurities. The pH is measured by the following method: Taking 10 g of gypsum sample, adding water to 100 g, stirring with a magnetic stirrer, and recording the pH value after stabilization.

Step 4: The synthetic gypsum is dried, ground, calcined to form gypsum powder containing 10˜50% alpha hemihydrate calcium sulfate, and then pulverized and stored.

Step 5: Gypsum slurry is formed by mixing gypsum powder, water, and auxiliary materials such as hardening agents, foaming agents, water-reducing agents, starch, retarders, etc.

Step 6: A top or face paper and a bottom or back paper are provided on the upper and lower sides respectively, and gypsum slurry is injected to form continuous wet boards, which are hardened, wet boards transfer handling and cutting, dried in a drying oven, and cut and trimmed to produce gypsum boards. According to the ASTM-C471M standard, the gypsum board produced by the present invention contains more than 10% alpha hemihydrate calcium sulfate.

The limestone (Calcium Carbonate) used in the present invention can be replaced with substances containing Calcium Carbonate, including minerals such as limestone, marble, Iceland spar or biological calcium oyster shell powder, etc.

The slaked lime (Ca(OH)₂) used in the present invention can be replaced with quicklime (CaO(s)) because slaked lime is produced by adding water to quicklime: CaO(s)+H₂O(1)→Ca(OH)₂(s).

While several embodiments have been described by way of example, it will be apparent to those skilled in the art that various modifications may be configured without departing from the spirit as defined by the appended claims.

What is claimed is:

1. A synthetic gypsum, produced by a process comprising:
step 1: mixing Calcium Carbonate (CaCO₃) and one of Calcium Hydroxide (Ca(OH)₂) and Calcium Oxide (CaO) in a predetermined ratio, adding water to form a suspension with a predetermined percentage of solid content; and
step 2: adding excess sulfuric acid under normal pressure, and stirring it, during which the temperature of the suspension rises and gas is generated, and meanwhile, gypsum is precipitated, and synthetic gypsum is obtained after drying.

2. The synthetic gypsum according to claim 1, wherein
in step 1, a predetermined amount of alpha-hemihydrate gypsum is added to the suspension as a crystal seed of dihydrate gypsum.

3. The synthetic gypsum according to claim 1, wherein
in step 1, a ratio of Calcium Carbonate (CaCO₃) and one of Calcium Hydroxide (Ca(OH)₂) and Calcium Oxide (CaO) is in a range of 2:1˜8.

4. The synthetic gypsum according to claim 1, wherein
in step 1, the solid concentration of the suspension after adding water is in a range of 20%˜40%.

5. The synthetic gypsum according to claim 2, wherein the predetermined amount of alpha-hemihydrate gypsum added is in a range of 0.3%˜5%.

6. The synthetic gypsum according to claim 1, wherein
in step 2, the excess sulfuric acid added refers to adding a 20%˜ 60% sulfuric acid solution, in a volume equivalent to approximately 1˜1.5 times a molar amount of Calcium.

7. The synthetic gypsum according to claim 1, wherein
in step 2, after the excess sulfuric acid is added, the solution is further adjusted to a pH of 3˜5 with dilute sulfuric acid.

8. The synthetic gypsum according to claim 2, wherein
a composition analysis according to ASTM-C471M standards, comprising: free water less than 10%, CaSO₄·2H₂O over 95%, particle size over 150 μm, pH 5˜8, and alpha hemihydrate gypsum 20%˜80%.

9. The synthetic gypsum according to claim 1, wherein
the entire process is carried out under normal pressure self-exothermic heat, no external heating is required.

10. A synthetic gypsum produced by the following process, which includes:
step 1: mixing Calcium Carbonate (CaCO₃) and one of Calcium Hydroxide (Ca(OH)₂) and Calcium Oxide (CaO) in a ratio of 2:1˜8, with water to form a suspension with 20%˜40% solid content;
step 2: slowly adding a 20%˜60% sulfuric acid solution at normal pressure in a volume equivalent to approximately 1˜1.5 times a molar amount of Calcium, stirring and mixing, during which the water temperature will continue to rise and gas will be produced, until gas production stops;
step 3: centrifuging dehydration, mixing with water, adding dilute sulfuric acid solution, stirring and mixing to adjust the pH to 3˜5, settling, precipitation, centrifuging, dehydrating, washing with water, and drying to produce synthetic gypsum.

11. A synthetic gypsum according to claim 10, wherein
in step 1, a 0.3%˜5% alpha-hemihydrate gypsum is added to the suspension as a crystal seed for dihydrate gypsum.

12. The synthetic gypsum according to claim 11, a composition analysis according to ASTM-C471M standards, comprising:
free water less than 10%; CaSO₄·2H₂O over 95%; particle size over 150 μm; pH 5˜8; alpha-hemihydrate gypsum approximately 20-80%.

13. A synthetic gypsum, a composition analysis according to ASTM-C471M standards, comprising:
free water less than 10%; CaSO₄·2H₂O greater than 95%; particle size greater than 150 μm; pH 5˜8; and alpha-hemihydrate gypsum approximately 20-80%.

14. A process for producing a gypsum board, comprising the following steps:
step 1: mixing a predetermined ratio of Calcium Carbonate (CaCO₃) and one of Calcium Hydroxide (Ca(OH)₂) and Calcium Oxide (CaO); and adding water to form a suspension with a predetermined concentration of solid;
step 2: slowly adding a predetermined concentration of sulfuric acid solution under normal pressure, with a volume that is a predetermined multiple of Calcium, and stirring it. At this time, the water temperature will continue to rise and gas will be generated until the gas production stops;
step 3: Centrifuging, dehydrating, adding water and mixing with a dilute sulfuric acid solution to adjust the pH to 3˜5, allowing it to settle, centrifuging, dehydrating, washing with water, drying, and producing synthetic gypsum;
step 4: drying, grinding, and calcining the synthetic gypsum to produce 10˜50% alpha-hemihydrate calcium sulfate plaster powder, and then pulverizing and storing;
step 5: forming a gypsum slurry by mixing the plaster powder, water, and auxiliary materials; and
step 6: injecting the gypsum slurry into a paper-lined mold with a top or face paper and a bottom or back paper, forming, hardening, wet boards transfer handling and cutting, drying, cutting, and trimming to produce gypsum board products.

15. The gypsum board according to claim 14, wherein
in step 1, a predetermined amount of alpha-hemihydrate gypsum is added to the suspension as a crystal seed of dihydrate gypsum.

16. The gypsum board according to claim 15, wherein
in step 1, the predetermined amount of alpha-hemihydrate gypsum is 0.3%˜5%.

17. The gypsum board according to claim 15, a composition analysis according to ASTM-C471M standards, comprising at least 10% of alpha-hemihydrate calcium sulfate.

18. A gypsum board is made by the following process, which includes:
step 1: mixing Calcium Carbonate (CaCO₃) with one of “calcium hydroxide (Ca(OH)₂) and calcium oxide (CaO)” in a ratio of 2:1˜8, adding water to a suspension with a solid concentration of 20%˜40%;
step 2: slowly adding 20%˜60% sulfuric acid solution at normal pressure, with a volume equal to approximately 1˜1.5 times the molar amount of calcium, stirring and mixing. At this time, the temperature of the suspension rises and gas is generated until gas production stops;
step 3: centrifuging dehydration, mixing with water, adding dilute sulfuric acid solution, stirring and mixing, adjusting the pH to 3˜5, allowing it to settle and precipitate, centrifuging dehydration, washing with water, and drying to produce synthetic gypsum;
step 4: the synthetic gypsum is dried, ground, and calcined to produce a plaster powder containing 10˜50% alpha-hemihydrate calcium sulfate, which is then pulverized and stored;
step 5: mixing the plaster powder, water, and auxiliary materials to form a gypsum slurry; and
step 6: injecting the gypsum slurry into a paper-lined mold, with a top or face paper and a bottom or back paper, continuously forming, hardening, wet boards transfer handling and cutting, drying, and trimming to produce gypsum boards.

19. The gypsum board according to claim 18, wherein
in step 1, a 0.3%˜5% of alpha-hemihydrate gypsum is added in the suspension as a crystal seed of dihydrate gypsum.

20. A gypsum board, a composition analysis according to ASTM-C471M standards, comprising:
at least 10% alpha-hemihydrate calcium sulfate.
